(19) United States
(12) Patent Application Publication
(10) Pub. No.: US 2014/0379606 A1
(43) Pub. Date: Dec. 25, 2014

(54) APPARATUS AND METHOD FOR END USER FREIGHT TRANSPORTATION MONITORING

(71) Applicant: Trakkx.com, LLC, Encinitas, CA (US)

(72) Inventor: John Lozito, Encinitas, CA (US)

(21) Appl. No.: 14/473,850

(22) Filed: Aug. 29, 2014

Related U.S. Application Data
(63) Continuation of application No. 12/395,626, filed on Feb. 28, 2009.

(51) Int. Cl. G06Q 10/08; B60Q 1/26; H04W 4/02

(52) U.S. Cl. CPC G06Q 10/0833; H04W 4/027; B60Q 1/26
USPC 705/333

(57) ABSTRACT

A method is disclosed for an improved consumer oriented secure surveillance system directed to a freight hauling. The method disclosed includes that an authorized tractor driver (e.g., contractor) and/or authorized tractor and the trailer (provided by the consumer) utilize a specified authorization code. A location tracking device is attached to the trailer and stores the specified authorization code. Location information of the location tracking device and the authorized tractor driver and/or an authorized tractor are monitored by an end-user along a destination route. The consumer can control usage of unauthorized tractor driver(s) (e.g., subcontractor(s)) and/or and unauthorized tractor(s) (e.g., subcontractor's tractor(s)) for freight shipment; thus, freight integrity can be controlled, optimized, and maintained to a desired consumer confidence level.

### CROSS-REFERENCE

This application is a continuation application of Ser. No. 12/395,626, filed Feb. 28, 2009, which is hereby incorporated by reference in its entirety.

### BACKGROUND OF THE INVENTION

1. Field of the Invention

The invention relates generally to the field of freight transportation and trailer assemblies, and specifically in one exemplary aspect to an end user tractor and trailer integrity monitoring system.

2. Description of Related Technology

Freight systems are well known in the art. Such systems are utilized to improve monitoring and prevent spoilage or damage or tampering to freight in transit while in a trailer. Some related art patents discussed below (and incorporated by reference in their entirety) are representative art of these conventional assemblies. In one related art example, U.S. Pat. No. 7,484,663 issued Feb. 3, 2009, by Olsen et al. entitled “Methods and systems for automating inventor and dispatch processes at a staging area” discloses a method whereby inbound vehicle and related container devices triggers a series of automated communications that facilitate the dispatch of items”. In yet another related art example, U.S. Pat. No. 7,479,901 issued on Jan. 20, 2009 entitled “Mobile thing determination systems and methods based upon user-device location” by Horstenmeyer discloses an automated method to monitor travel data associated with a first personal communications device (PCD) and a second communications device including proximity of the first PCD to a location.

In yet another related art example, U.S. Pat. No. 7,312,702 issued on Dec. 25, 2007 entitled “Expediting release procedure of cargo container at border crossing or at customs entry point by tracking and reporting threats while cargo container is in transit” by Willms, et al. discloses a method for expediting a release procedure of at least one cargo container at least one border crossing or at least one customs entry point by detecting each statistically significant threat (SST) signal associated with at least one said cargo container while in transit, and by tracking and reporting to an appropriate party the position coordinates and a security status of each cargo container that generated at least one said SST signal.” In yet another related art, U.S. Pat. No. 7,482,952 by inventor Horstemeyer that issued on Jan. 27, 2009, disclosed communications in connection with a computer-based notification system and a personal communication device associated with a party that can modified in which future notification communications are implemented, based upon the response.

In contrast to the above instances, a freight system may further be desired to achieve still wider variety of protection and/or informational options and provide improved end user (e.g., consumer) control and monitoring system as well as provide various types of and configurations that are adjustable to fit a user's scheme without requiring complicated electronic hardware or software configurations.

Thus, what is needed are improved freight apparatus and methodology that permits easy initial configuring and reconfiguring, i.e., provide adaptability, and upgrade capability so that the same unit be utilized (or added-on to) if new functionality (e.g., security scheme) is desired. Furthermore, such improved apparatus and methods would also ideally allow a person other than a professional or licensed personal to monitor freight using the freight systems, and would further permit creation of user-customized configurations and customized fit as well as new patterns requiring minimal efforts, e.g., minimal adjustment or removal and replacement or adaptation of existing components.

### SUMMARY OF THE INVENTION

In a first aspect of the invention, a method is disclosed for an end user of a freight system to track location coordinate information of a tractor driver and a tractor. The method discloses that an authorized tractor driver (e.g., contractor driver) and/or authorized tractor (e.g., contractor tractor) and the trailer utilize a specified authorization code (e.g., vehicle identification number) between two transportation nodes. In one embodiment, a location tracking device (e.g., global positioning (GPS) tracking device) assigns and stores remotely the specified authorization code. In one variant, the location tracking device is attached to the trailer connected to the authorized tractor. In another variant, the location information of the location tracking device and the at least one of the authorized tractor driver and an authorized tractor for a designation or arrival time is monitored along one or more stops of a destination route.

In a second aspect of the present invention, a customer-based remote location monitoring system is disclosed. In one embodiment, a location tracking device located on the trailer carries the freight. The location tracking device is programmed with an identification number the same as that of one or more of the following the tractor driver, or the tractor. In one variant, the identification number includes a government certification code stored on a secure database and associated with one of the tractor driver and/or the tractor. In another variant, the government certification code includes information regarding licensing and authorization codes that may indicate a level of skill or authorization level of the tractor or the tractor driver for a specific shipment of goods.

In another embodiment, an electronic logic apparatus is associated with the consumer-based location monitoring system to provide security surveillance and to transmit a unique data set while on the transportation route for a preselected condition of or associated with a type of freight on the trailer and/or type of tractor.

In a third aspect of the present invention, a location coordinate monitoring apparatus is disclosed providing secure surveillance of integrity of tractor, tractor driver, and trailer and freight therein between and among a plurality of wireless accessible nodes while the trailer is in transit. In one embodiment, a location tracking device associated is with the freight in transit or on a transportation route. Continuing with this embodiment, the location tracking device programmed with an identification number identical to the identification number (e.g., paired identification numbers) of the trailer to provide a user substantially real-time information on integrity of the trailer. In yet another embodiment, the end user receives substantially automatically records and/or alerts upon apparatus detecting the trailer is driven by an unauthorized tractor and that integrity of its contents have been compromised.

These and other embodiments, aspects, advantages, and features of the present invention will be set forth in part in the description which follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

FIG. 1 is a pictorial representation of a freight system illustrating end user computer that monitors a trailer and tractor and commercial database of authorized tractors and authorized tractor drivers in accordance with an embodiment of the present invention.

FIG. 2 is a pictorial representation of a trailer, an unauthorized and an authorized tractor, and an unauthorized and authorized tractor driver in accordance with an embodiment of the present invention.

FIG. 3 is a pictorial representation of a freight system illustrating temperature control and temperature regulation by an end user of a trailer in accordance with an embodiment of the present invention.

FIG. 4 is a logical flow diagram illustrating one exemplary embodiment of a process for a freight system in accordance with an embodiment of the present invention.

### DETAILED DESCRIPTION OF THE INVENTION

Reference is now made to the drawings wherein like numerals refer to like parts throughout.

### Overview

In one salient aspect, the present invention discloses apparatus and methods for, inter alia, producing a freight system as well as provide custom capabilities, in one variant, to produce various configurations to conform to, for instance, expectations of a consumer including monitoring of physical attributes thereof including integrity of a trailer, condition of freight, temperature of trailer and its contents, humidity, or the like. In particular, the present invention discloses an apparatus and process to provide an freight system having a integrity feature, for instance, to meet a user's individual security surveillance goals, e.g., make sure that a trailer is attached to an authorized tractor or driven by an authorized tractor driver to meet a user's needs to achieve quality control, prevent spoilage, provide improved security properties, or a combination thereof.

In particular, the present invention discloses an apparatus and process to provide an freight system having a integrity feature, for instance, to meet a user's individual security surveillance goals, e.g., make sure that a trailer is attached to an authorized tractor or driven by an authorized tractor driver to meet a user's needs to achieve quality control, prevent spoilage, provide improved security properties, or a combination thereof.

Furthermore, the present invention discloses a freight apparatus applicable to monitor location coordinate information of freight while on a transportation route, during non-compliance. For instance non-compliance may be end user specified when an unauthorized tractor or unauthorized tractor driver is hauling the trailer, e.g., an unlicensed contractor or a licensed, unapproved subcontractor. For instance in one or more embodiments, non-compliance may be end user specified when a trailer's doors (e.g., doors 123) are opened or integrity of freight, e.g., cargo, is in the process of being compromised, contaminated, stolen, damaged, inadequately heated, cooled, or humidified.

In light of the present invention, users may customize and choose a desired level of secure surveillance responsive to a chosen type of or quantity of freight or temperature or quality of environment or environment for a particular day or event; thus, this present inventive apparatus provides adaptability as compared with conventional freight systems having fixed capabilities. Furthermore, the freight apparatus includes a tracking and location device, e.g., a wireless location tracking device (e.g., global position system (GPS) tracking device), to improve end user control and knowledge (increasing user real-time awareness on location and quality of freight) and increase user real-time control of freight movement (provide built-in flexibility).

In addition, the freight apparatus integrates one or more commercial databases including authorized contractor qualifications and relative distance between them and the trailer including the freight using an authorized code, e.g., vehicle identification number or government identification number, to increase security and secret surveillance of freight throughout one or more transportation route(s).

Accordingly, the apparatus advantageously allows multiple configuration styles and supports many different system configurations through its ability to provide a significant flexibility of user adjustment to create new “customized” fit, e.g., using, for instance, using an software algorithm that is Internet accessible to allow any computer terminal or entry device to monitor the trailer and its contents, e.g., location tracking device on the trailer, or sensors on the trailer (e.g. temperature or humidity monitoring) proximal to the freight and to provide quick-web access entry and exit ports. In addition, the principles of the present invention are applicable to other applications, e.g., security systems, temperature control and regulation systems in a remote warehouse setting, and location tracking of items in transit or on route in a transportation systems, e.g. cars, boats, airplanes, or multi-mode and destination freight system.

### Exemplary Extension Apparatus

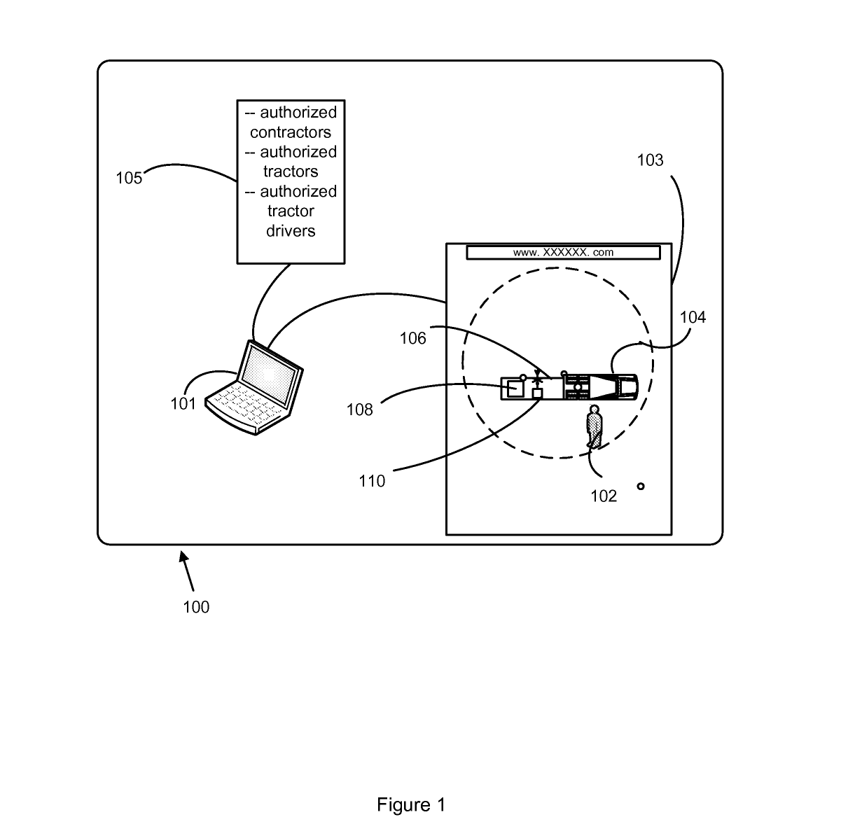

Referring now to FIGS. 1-3, exemplary embodiments of a freight system and apparatus of the invention are described in detail. It will be appreciated that while described primarily in the context of a freight apparatus, at least portions of the apparatus and methods described herein may be used in other applications, such as for example and without limitation applications including temperature control and security system environment. Moreover, it will be recognized that the present invention may find utility beyond purely freight system concerns.

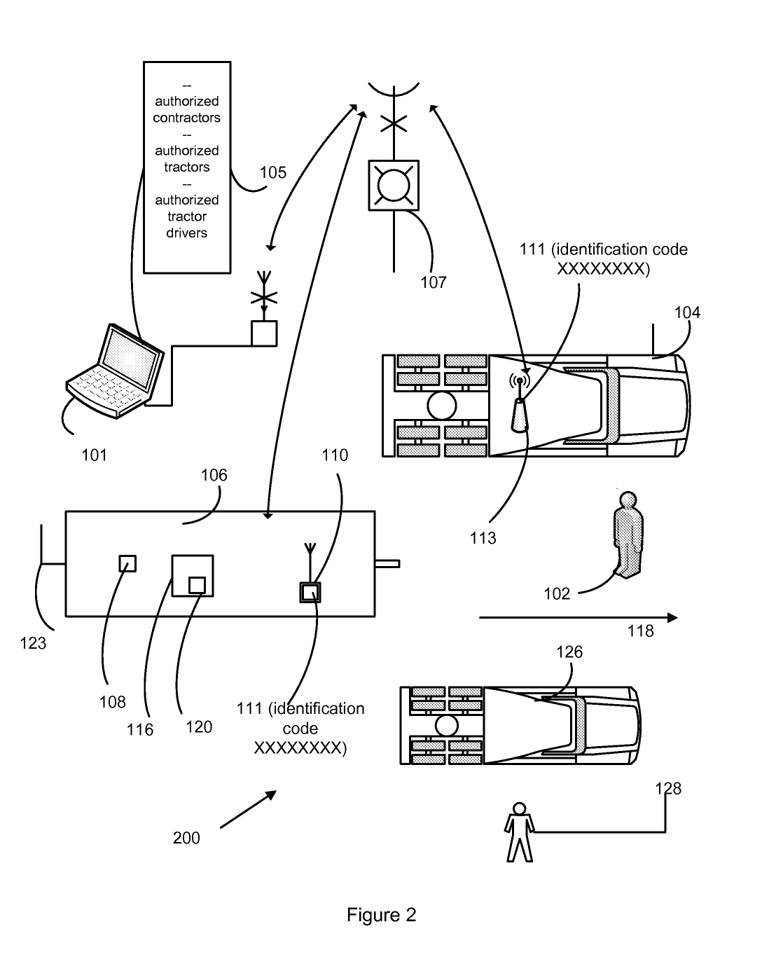

As best illustrated in FIGS. 1 and 2, a customer-based remote location monitoring system 100 is disclosed. System 100 includes consumer computer 101 with screen display 103. Database 105 includes attributes and information for example but not limited to authorized contractors, authorized tractor trailer drivers, authorized tractors. In one embodiment, system 100 is capable of detecting if contents (e.g. freight 108) of has been tampered with or altered in one or more ways. For example, system 100 detects if items have been added to freight 108 of trailer 106. In one embodiment, freight system integrity is monitored through location coordinate technology. For instance, GPS tracking software stored on or accessible through an Internet server through computer 101 monitors location coordinate movements or delta changes between trailer 106 and one or more of the following: authorized tractor driver 102 (e.g., having cell phone GPS or GSM location monitoring capability), authorized tractor 104, and freight 108 disposed in trailer 106.

In one embodiment, an end user disposes location tracking device 110 (e.g., GPS tracking device) on trailer 106 that carries freight 108. In one embodiment, location tracking device 110 (e.g., a location monitoring or tracking device) is programmed with identification number 111 (e.g., authorization code). In one embodiment, identification codes are paired between location devices on trailer 106 and the authorized tractor 104 and/or authorized tractor driver 102. In one variant, identification number 111 is consistent with, e.g., same as, that held or associated with authorized tractor driver 102. In another variant, identification number 111 is consistent with, or the authorized tractor.

In one embodiment, identification number 111 includes a government certification code stored on secure database 112 and may be associated with authorized tractor driver 102 (having wireless tractor tracking device 113) and authorized tractor 104. For example, the government certification code includes information regarding licensing and authorization codes. In one aspect, the licensing and authorization codes may partially indicate a level of skill or authorization level of authorized tractor driver 102 and authorized tractor 104 in accordance a type of freight 108 or a quantity of goods in a shipment of freight 108.

In yet another embodiment, location tracking device 110 may be, for instance, welded to, bolted to, one-way bolted to, tack welded, otherwise attached either in a concealed or at least partially concealed manner to trailer 106. In one variation of this embodiment, upon unauthorized removal, location tracking device 110 communicates a signal, e.g., wirelessly, including an alarm signal to authorized tractor 104 having identification number 111. In yet another embodiment, location tracking device 110 communicates an alarm signal to alert a consumer or end user of unauthorized removal thereof that includes identification number 111. In one variant, electronic logic apparatus 116 is associated with the consumer-based location monitoring system 100 to provide security surveillance and to transmit a unique data set while trailer 106 is on a transportation route 118 that is response to a preselected condition. The preselected condition may be partially associated with the type of freight on the trailer and a type of tractor.

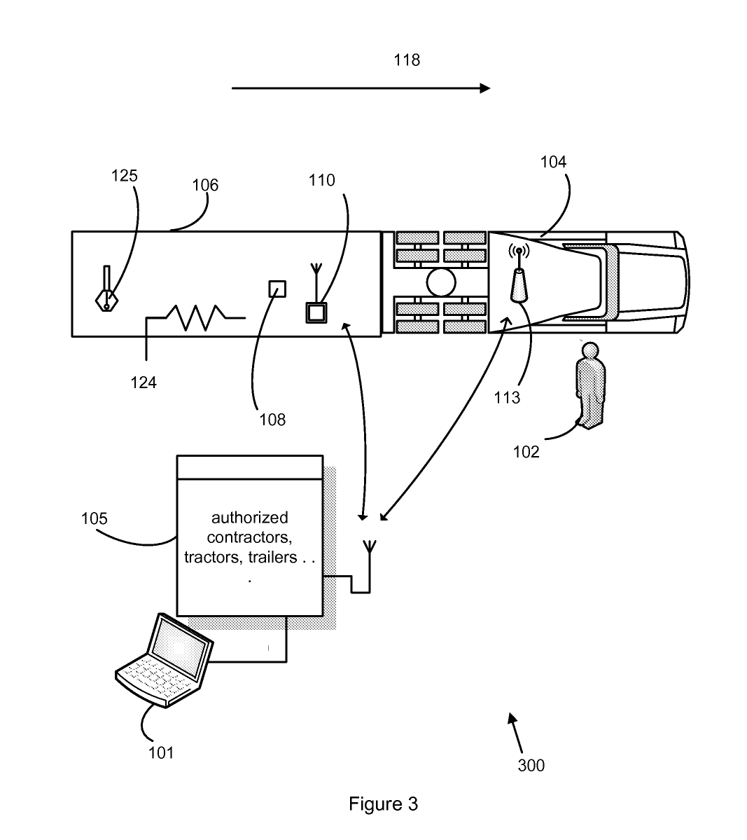

As best illustrated in FIG. 3, electronic logic apparatus 116 comprises electronic circuitry 120 to monitor trailer 106 along the transportation route 118 responsive to weather and road conditions. In another variant, electronic logic apparatus 116 accesses a multitude of electronic database (e.g., database 105) and is responsive to location coordinates on an at least a semi-continuous or periodic basis. The location tracking device 110 and wireless tracking device 113 communicate signals (e.g., identification number 111). In one embodiment, the signals travel between computer 101 through wireless communication relay station 107 (e.g., ground based transceiver station, GPS satellite, or the like) and location tracking device 110 and wireless tracking device 113. In one variant, electronic logic apparatus 116 provides on at least a semi-continuous or periodic basis to one or more of the following: authorized tractor 104, authorized tractor driver 102 associated with freight 108, temperature information, humidity information, time sensitive fresh produce information, and time sensitive dry freight shipping information to at least one of the tractor and the tractor driver.

In yet another embodiment, electronic logic apparatus 116 includes a temperature regulation system 124 based on environmental readings provided by sensors (e.g., temperature or humidity sensors 125) to adjust temperature of trailer 106 or freight 108. As such, an end user may advantageously increase operational efficiency and lower overall cost while trailer 106 is in transportation route 118. In one variant, electronic logic apparatus 116 includes regulation system 124 to lower or raise temperature of trailer 106 or freight 108 that is responsive to changing weather conditions and road conditions. As such, system 300 advantageously may decrease problems associated with end-user refrigerated or perishable items in freight 108 because user-defined conditions may compensate for and be response to changing weather conditions (or other end-user defined events or conditions) to improve shelf life, e.g., decrease freight spoilage rate and increase shelf life.

In one embodiment, remote control monitoring system 300 may include at least two modes of transportation (e.g., multimode) selected from a train, boat, truck, and aircraft. In one embodiment, identification number 111 includes a government identification number that is associated with licensed tractor drivers. In another embodiment, identification number 111 uniquely identifies authorized tractor 106 from other tractors and determines if tractor driver is authorized tractor driver 104. In yet another embodiment, identification number 111 is utilized by an end user to determine if integrity of trailer 106 has been compromised through unauthorized movement or de-attachment of trailer 106 to unauthorized tractor 126 or hauling of trailer 106 by unauthorized tractor driver 128.

Advantageously, the present system in contrast to a conventional freight system allows a consumer to have a secure surveillance means to monitor integrity of tractor, tractor driver, and trailer and freight therein between a plurality of wireless accessible nodes while the trailer is in transit. Thus, a consumer will able to determine and monitor with significant accuracy the conditions and care of any freight transported over a chosen transportation route. Conventionally, a tractor driver executed almost exclusive control over how the freight was handled and who hauled the freight. Advantageously, the present system provide a consumer customized control of trailer and freight handling through preventing usage of unauthorized tractor driver(s) (e.g., subcontractor(s)) and/or and unauthorized tractor(s) (e.g., subcontractor's tractor(s)) for freight shipment; thus, an end user may more easily monitor freight integrity to control, optimize, and maintain a desired consumer confidence level.

Furthermore, the present system incorporating a location tracking device (e.g., GPS tracking device) associated with the freight in transit on the transportation route always easy tracking by a consumer, e.g., end user. Advantageously the tracking device being programmed with an identification number identical to the identification number of a trailer provides end-user (consumer) substantially real-time information using an Internet web access code or password to monitor integrity of the trailer.

In addition, because the system automatic records and/or alerts an end user upon detection of an authorized trailer being driven by an unauthorized tractor driver, unauthorized removal of the location tracking device, or upon connection of an authorized trailer to an unauthorized tractor; therefore, a consumer has the information necessary to know an extent of the freight being compromised and rectify a breach of integrity of its freight contents. Advantageously, identification number comprises real-time information on an authorized tractor trailer driver and authorized tractor so that a consumer may substantially instantaneous monitor freight on the authorized trailer without complicated number look-up tables or other agencies.

Furthermore, the identification number including real-time information from a multitude of commercial databases information on a list of authorized tractor trailer drivers to an end user allow an end user substantial control of integrity of the trailer while in transit. In addition, the system provides an alert message to an authorizing agency that the integrity of the trailer has been compromised.

Finally, because a tractor vehicle identification number is tied to a location tracking device, a location of the trailer having the location tracking device may be reported to an operating authority or equipment owner through an Internet portal including web software. Thus, a consumer, and end user will be able to ascertain who hauled or who is hauling the freight and/if an authorized tractor driver (authorized carrier) has contracted with a freight subcontractor; thus, a consumer will have control over and be able to track who or under what conditions the trailer was hauled under.

### Exemplary Methods

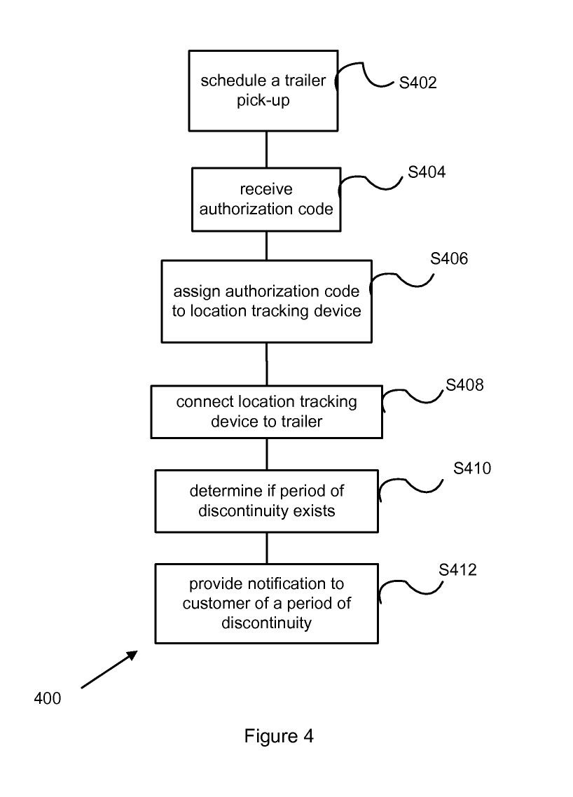

Referring now to FIG. 4, an exemplary embodiment of a method 400 for utilizing and assembling the aforementioned freight system is described. While described primarily in the context of the exemplary embodiments of apparatuses 100, 200, and 300 shown in FIGS. 1-3, it will be appreciated that the methodology presented herein may be readily adapted to many different configurations of the below method as recognized by those of ordinary skill in the art. In this exemplary embodiment, the end user desires to monitor integrity of freight or shipment particulars, e.g., temperature, humidity, location coordinates, or the like.

In step 402, an end user schedules pick-up of a trailer having freight for transport to another destination. In step 404, an end user (e.g., consumer) receives authorization code 111 that identifies authorized tractor driver 102 and/or authorized tractor 104 for the pick-up of trailer 106. In step 406, authorization code 111 is assigned and stored for location tracking device 110. In step 408, location tracking device 110 is attached to trailer 106. Afterwards, trailer 106 electronically connects to the at least one of authorized tractor 104 and authorized tractor driver 102. In one variation of step 408, an end user monitors the location information of location tracking device 110 and authorized tractor driver 102 and/or the authorized tractor 104 along one or more stops of a destination route.

In step 410, computer database 105 or programming software code (stored on computer 101 or Internet accessible through computer 101) determines if trailer 106 and one of authorized tractor 104 or authorized tractor driver 102 had a period of disconnectivity along the one or more stops of a destination route 118. In step 412, end user is notified if the period of the disconnectivity was more than a specified period between trailer 106 and one of authorized tractor 104 or authorized tractor driver 102.

It will be appreciated that while certain aspects of the invention have been described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A method for an end user of a freight system to monitor integrity of freight throughout a designation route, the method comprising:
scheduling pick-up of a trailer having freight for transport to another destination;
receiving an authorization code that identifies at least one of an authorized tractor driver and an authorized tractor for the pick-up of the trailer;
assigning and storing remotely the authorization code for a location tracking device;
attaching the location tracking device to a trailer;
electronically connecting the trailer to the at least one of the authorized tractor and the authorized tractor driver;
monitoring the location information by the end user of the location tracking device and the at least one of the authorized tractor driver and the authorized tractor along one or more stops of a destination route;
determining if the trailer and at least one of the authorized tractor or the authorized tractor driver had a period of disconnectivity along the one or more stops of the destination route; and
providing notification to the end user if the period of the disconnectivity was more than a specified period between the trailer and at least one of the authorized tractor or the authorized tractor driver.

2. The method of claim 1, further comprising the step of providing location information at the period of the discontinuity if the period of the disconnectivity was more than the specified period between the trailer and the at least one of the authorized tractor and the authorized tractor driver; and wherein the end user comprises a customer.

3. The method of claim 1, wherein the authorization code comprises a government identification number that is associated with licensed tractor drivers in one or more commercial databases or contractor monitoring agencies.

4. The method of claim 2, wherein the authorization code comprises an identification number to uniquely identify the authorized tractor from other unauthorized tractors and to determine if the authorized tractor driver is present.

5. The method of claim 2, wherein the authorization code comprises an identification code used by the end user to determine if integrity of the trailer has been compromised through unauthorized movement or de-attachment of the trailer to an unauthorized tractor or movement by an unauthorized tractor driver.

6. The method of claim 1, further comprising the steps of receiving an alert message from the location tracking device that detected the trailer is being carried by an unauthorized tractor or unauthorized tractor driver and that contents of the trailer have lost their integrity; and contacting a monitoring agency that the integrity of the freight has been compromised.

7. The method of claim 2, further comprising the step of monitoring by the end user one or more doors of the trailer to determine if the integrity of the trailer or the freight have been compromised; and alerting an overseeing agency associated with the trailer or the authorized tractor of a possible loss of the integrity of the freight or the trailer.

8. The method of claim 1, wherein the step of providing notification to the end user comprises providing remote computer notification of the authorization code while the trailer is in transit among one or more stops of the destination route.

9. The method of claim 8, further comprising the step of monitoring the location information by the end user comprises the end user evaluating in real-time qualifications of a current tractor driver and real-time status of freight in the trailer.

10. A customer-based remote location monitoring system for detecting if a breach of integrity has occurred between at least one of an authorized tractor driver and an authorized tractor and a trailer comprising freight attached to a tractor, the system comprising:
a location tracking device located on the trailer carrying the freight, the location tracking device programmed with an identification number the same as that of at least one of the authorized tractor driver, or the authorized tractor, the identification number comprising a government certification code stored on a secure database and associated with at least one of the authorized tractor driver and the authorized tractor;
wherein the government certification code comprises information regarding licensing and authorization codes that at least partially indicate a level of skill or authorization level of the authorized tractor or the authorized tractor driver in accordance a type of freight or a quantity of goods in a shipment of the freight; and
an electronic logic apparatus associated with the consumer-based location monitoring system to provide security surveillance and to transmit a unique data set while on the transportation route for a preselected condition at least partially associated with the type of freight on the trailer and a type of tractor to determine if integrity has been compromised.

11. The system of claim 10, wherein the electronic logic apparatus comprises electronic circuitry to monitor for the trailer on route weather and road conditions from a multitude of electronic databases that is responsive to location coordinates on an at least a semi-continuous or periodic basis to provide on at least a semi-continuous or periodic basis to at least one of the authorized tractor and the authorized tractor driver at least two of the following associated with the freight: temperature information, humidity information, time sensitive fresh produce information, and time sensitive dry freight shipping information to at least one of the authorized tractor and the authorized tractor driver.

12. The system of claim 10, wherein the electronic logic apparatus comprises a temperature regulation system to adjust temperature of the trailer or the freight to increase operational efficiency and lower overall cost while the trailer is in transportation route.

13. The system of claim 10, wherein the electronic logic apparatus comprises a regulation system to lower or raise the temperature of the trailer or the freight in response to changing weather conditions and road conditions to decrease problems associated with refrigerated or perishable freight.

14. The system of claim 10, wherein the remote control monitoring system comprises at least two modes of transportation selected from a train, boat, truck, and aircraft.

15. The system of claim 10, wherein the identification number comprises a government identification number that is associated with licensed tractor drivers.

16. The system of claim 10, wherein the identification number uniquely identifies the authorized tractor from other tractors and to determine if the authorized tractor driver is an authorized individual.

17. The method of claim 10, wherein the identification number is utilized by the end user to determine if integrity of the trailer has been compromised through unauthorized movement or de-attachment of the trailer to an unauthorized tractor or the trailer being driven by an unauthorized tractor driver.

18. A location coordinate monitoring apparatus to create secure surveillance and increase a user confidence level of an integrity of tractor, tractor driver, and trailer and freight therein between a plurality of wireless accessible nodes while the trailer is in transit, the apparatus comprising:
a location tracking device associated with the freight in transit on the transportation route, the location tracking device programmed with a identification number identical to the identification number of the trailer to provide a user substantially real-time information on the integrity of the trailer and substantially in an automatic mode records and/or alerts an end user upon detection that the trailer is being driven by an unauthorized tractor driver or connected to an unauthorized tractor and that an integrity of its contents have been compromised.

19. The apparatus of claim 18, wherein the identification number comprises real-time information on the authorized tractor driver and the authorized tractor.

20. The apparatus of claim 18, wherein the identification number comprises real-time information from a multitude of commercial databases information on a list of authorized tractor trailer drivers to an end user; and the integrity of the trailer comprises status information on the freight in the trailer.

21. The apparatus of claim 19, wherein the alert message comprises contact of an authorizing agency that the integrity of the trailer has been compromised.
